(19) United States
(12) Patent Application Publication
(10) Pub. No.: US 2021/0409226 A1
(43) Pub. Date: Dec. 30, 2021

(54) REVERSIBLE BLOCKCHAIN TRANSACTION TECHNIQUES

(71) Applicant: Kirobo LTD., Tel Aviv (IL)

(72) Inventor: Tal ASA, Givat Shmuel (IL)

(73) Assignee: Kirobo LTD., Tel Aviv (IL)

(21) Appl. No.: 17/358,215

(22) Filed: Jun. 25, 2021

Related U.S. Application Data
(60) Provisional application No. 63/045,460, filed on Jun. 29, 2020.

(51) Int. Cl. H04L 9/32; G06F 21/64; G06F 21/60

(52) U.S. Cl. CPC H04L 9/3239; H04L 2209/38; G06F 21/602; G06F 21/64

(57) ABSTRACT

A system and method for creating reversible blockchain transactions. A method includes determining a hidden address for a transaction to be uploaded to a blockchain, wherein the hidden address is an internal address of a device indicating at least one parameter that causes the hidden address to be inaccessible to a blockchain-utilizing application installed on the device; and generating a reversible transaction based on the determined hidden address.

### CROSS-REFERENCE TO RELATED APPLICATIONS

This application claims the benefit of U.S. Provisional Application No. 63/045,460 filed on Jun. 29, 2020, the contents of which are hereby incorporated by reference.

### TECHNICAL FIELD

The present disclosure relates generally to blockchain transactions, and more particularly to adapting blockchain transactions for reversible implementations.

### BACKGROUND

Blockchain technology utilizes distributed ledgers to record transactions across various computers among a peer-to-peer network. Blocks are added sequentially as transactions occur. Each block in the blockchain includes a time stamp, transaction data, and a cryptographic hash of the previous block's data. When a new block will be added to the blockchain, the cryptographic hash of the new block is verified by all computers on the peer-to-peer network.

Blockchain technology has been adapted for various uses such as financial transactions (referred to as cryptocurrencies), enforcement of contractual terms (referred to as smart contracts), storing sensitive data (e.g., private medical data), and the like. In each of these adaptations, the blockchain technology ensures data integrity since the blockchain cannot be tampered with. Additionally, the data may be anonymized.

Adding data according to existing blockchain solutions is an irreversible process. In other words, once transaction data is signed by a transferring party, the transfer cannot be reversed. Although this characteristic of existing solutions ensures integrity of the data stored on the blockchain, it may be desirable for some uses of blockchain to allow for reversible transactions. For example, purchases made using Bitcoin may need to be reversed if a purchase item is returned or is defective and must be refunded. As another example, it may be desirable to reverse a transaction when transaction data includes an error.

Due to the irreversible nature of existing solutions for blockchain transactions, existing solutions require that another transaction be added to the blockchain in order to reverse any previously added transactions. This extra transaction adds to the total amount of data making up the blockchain and requires additional communications among the peer-to-peer network. Further, such additional transactions may require cooperation from the recipient of the transfer, which in some cases may not be possible.

It would therefore be advantageous to provide reversible blockchain transactions.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for creating reversible blockchain transactions. The method comprises: determining a hidden address for a transaction to be uploaded to a blockchain, wherein the hidden address is an internal address of a device indicating at least one parameter that causes the hidden address to be inaccessible to a blockchain-utilizing application installed on the device; and generating a reversible transaction based on the determined hidden address.

Certain embodiments disclosed herein also include a non-transitory computer readable medium having stored thereon causing a processing circuitry to execute a process, the process comprising: determining a hidden address for a transaction to be uploaded to a blockchain, wherein the hidden address is an internal address of a device indicating at least one parameter that causes the hidden address to be inaccessible to a blockchain-utilizing application installed on the device; and generating a reversible transaction based on the determined hidden address.

Certain embodiments disclosed herein also include a system for creating reversible blockchain transactions. The system comprises: a processing circuitry; and a memory, the memory containing instructions that, when executed by the processing circuitry, configure the system to: determine a hidden address for a transaction to be uploaded to a blockchain, wherein the hidden address is an internal address of a device indicating at least one parameter that causes the hidden address to be inaccessible to a blockchain-utilizing application installed on the device; and generate a reversible transaction based on the determined hidden address.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a method for creating reversible blockchain transactions according to an embodiment.

FIG. 3 is a block diagram illustrating a reversible blockchain transaction recorder according to an embodiment.

FIG. 4 is a data transmission diagram utilized to describe generation of the key for decrypting the signed transaction data according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Although reversible transactions in blockchain applications would be desirable, such reversible transactions should not compromise the integrity of data to be stored on a blockchain. To this end, the disclosed embodiments provide techniques which allow for reversing transactions that will be recorded on a blockchain. Moreover, the disclosed embodiments do not require tampering with the blockchain and, therefore, do not interfere with the inherently secure nature of blockchain transactions. Further, the disclosed embodiments do not require additional transactions that “reverse” the original transaction by returning the transferred assets via a new transaction.

The various disclosed embodiments include techniques for creating reversible blockchain transactions. In an embodiment, a request to initiate a transaction is received from a first party to a transaction via a first user device of the first party. The transaction includes a transfer of a digital asset such as, but not limited to, funds, digital keys or other data granting permission to use or control one or more systems, one or more data objects, one or more other digital items which represent ownership of real-world objects, and the like. The request includes data for the transaction signed by the first user device. Transaction data is created based on the signed data, and a hidden address is designated for the transaction. The hidden address is an address on the blockchain which is internal to the first device but hidden to an application which participates in transactions to be recorded on blockchain, i.e., an address which is not known to that application and therefore cannot be accessed by that application.

The address indicates a path composed of one or more parameters. In an embodiment, the address is a hidden address with an address including one or more nonstandard parameters such that a blockchain-utilizing application installed on the transferring user device does not recognize the hidden address. The address may be a simple address or a smart address. A simple address points to a location in storage. A smart address points to a location in storage and also includes logic capable of being utilized by computer programs or transaction protocols to provide functionality.

In a further embodiment, the address is a simple address including a change parameter value. The change parameter value indicates the relative visibility of the digital asset to the first user device. Some existing solutions utilize a value in the address indicating whether the address is visible or not to a program that utilizes a blockchain to record transactions. Such a program may be, for example, a cryptocurrency wallet. For example, such a solution may use a constant 0 as the change value to represent an internal address and a constant 1 as the change value to represent an external address. The disclosed embodiments utilize a nonstandard value (as a non-limiting example, a constant 2). Thus, the address including this hidden change value is a hidden address that points to a location which is inaccessible to the blockchain-utilizing program but can be accessed by the first user device upon reversal of the transaction.

In another embodiment, the address is a smart address including logic for preventing the blockchain-utilizing application installed on the first user device from accessing the underlying data. To this end, such logic may define a list of blocked applications that are not permitted to access the data.

By utilizing an address which is not known to the relevant application installed on the first user device, that application will not recognize possession of the transferred asset. Consequently, the first party cannot use or otherwise access the asset. However, the transferred asset may still be accessed upon request for reversal of the first party using the hidden address. Thus, if a transaction is reversed, use or ownership of the transferred assets may be returned to the first party without requiring altering the blockchain on which the transfer was recorded. As a result, the transaction can be reversed without disrupting the integrity of the data stored on the blockchain or requiring additional transactions to return the transferred assets.

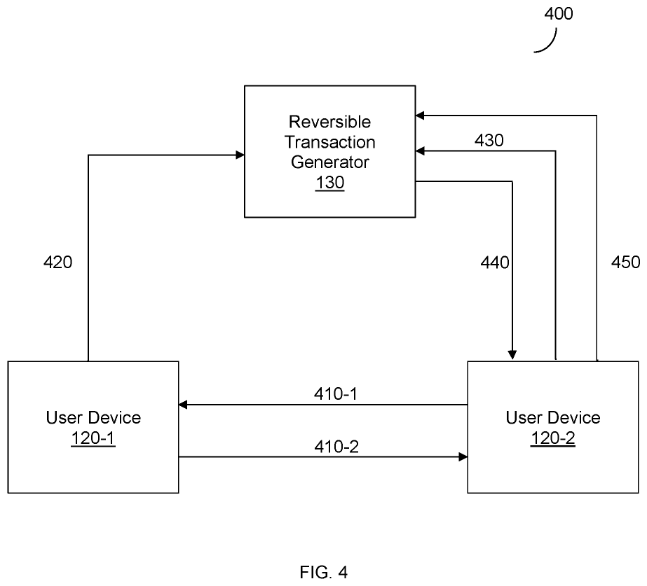

In an embodiment, a key used for decrypting the encrypted signed transaction data is received from a second user device operated by a second party. The key is generated based on data sent by the first user device to the second user device. An example implementation for generating the key is described further with respect to FIG. 4. The received key is used to decode the signed data received from the first user device. When the signed data has been decoded, it is uploaded to a blockchain.

By using a key generated based on data sent from the first user device to the second user device, the transaction is secured. More specifically, even if the signed transaction data is sent to the wrong system, the receiving system will not be able to decrypt the signed transaction data and, therefore, will not be able to send the decrypted data for recording on the blockchain.

The disclosed embodiments allow for reversing transactions without introducing potential issues related to the double spending problem, i.e., a problem which occurs when a digital asset is “transferred” twice. More specifically, the blockchain-utilizing program does not “see” the digital asset stored at the hidden address. For example, when the program is a wallet program, the wallet program will recognize that a certain sum of cryptocurrency has been transferred and will therefore reduce the amount of cryptocurrency available to the user of the wallet program. However, because the transaction data is still stored on the same user device, the cryptocurrency can be refunded without risking spending that sum twice. According to various disclosed embodiments, transactions may be reversed until the transaction data is successfully uploaded to the blockchain.

Additionally, the disclosed embodiments do not require use of a particular application installed on the user device. In other words, the disclosed embodiments do not require installing a reversible transaction agent on the user devices. More specifically, by utilizing a nonstandard address as described herein, the reversibility of the transaction may be achieved without reconfiguring the user device. This provides additional convenience and security. More specifically, applications installed on the transferring user device are not required to attempt to tamper with the blockchain or to modify the data on the transferring user device, thereby ensuring the integrity of the data.

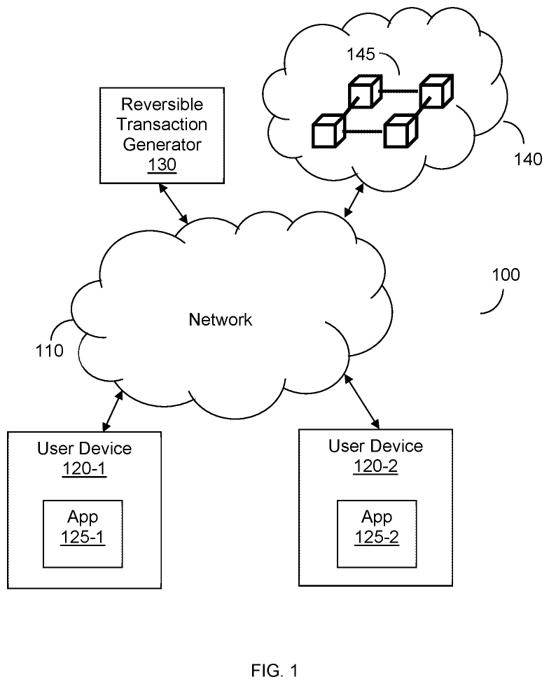

FIG. 1 shows an example network diagram 100 utilized to describe the various disclosed embodiments. In the example network diagram 100, user devices 120-1 and 120-2, a reversible transaction generator 130, and a blockchain network 140 are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

Each user device (UD) 120 may be, but is not limited to, a personal computer, a laptop, a tablet computer, a smartphone, a wearable computing device, and the like. Each user device 120 is configured to participate in transactions to be recorded via the blockchain network 140. To this end, each user device 120 may have a respective blockchain-utilizing application (app) 125 installed thereon. The blockchain-utilizing application 125 is configured to participate in transactions. As a non-limiting example, the blockchain-utilizing application 125 may be a wallet application used to transfer and receive funds, where any transfers or receipt of funds.

The blockchain network 140 is a peer-to-peer network collectively storing a blockchain 145. The blockchain network 140 is composed of multiple computers (not shown), each of which stores a copy of the blockchain 145. Transaction data is added to the blockchain in blocks, and the computers of the blockchain network 140 participate in a consensus algorithm for all blocks to be added to the blockchain 145.

The reversible transaction generator 130 is configured to perform one or more of the embodiments disclosed herein. To this end, the reversible transaction generator 130 receives signed transaction data and a decryption key for decrypting the signed transaction data. The signed transaction data is received from a first user device of the user devices 120 (e.g., the user device 120-1) and the decryption key is received from a second user device of the user devices 120 (e.g., the user device 120-2). When the signed transaction data and decryption key are received, the reversible transaction generator 130 decrypts the transaction data and uploads the decrypted data to the blockchain network 140 for storage in a block (not shown) of the blockchain 145. More specifically, the decrypted data is broadcast to peer computers among the blockchain network 140, the peer computers validate the transaction based on the broadcast data, and the decrypted data is added as a block of the blockchain when the transaction has been validated.

It should be noted that two user devices 120 and one blockchain network 140 including one blockchain 145 are illustrated in FIG. 1 for simplicity purposes, but that the disclosed embodiments may be equally applicable to other communication configurations.

One such other configuration may include a single user device 120 including two or more blockchain-utilizing applications 125. Such a configuration may be utilized to perform back up and inheritance of the contents of one blockchain-utilizing application 125 as described further below with respect to FIG. 4.

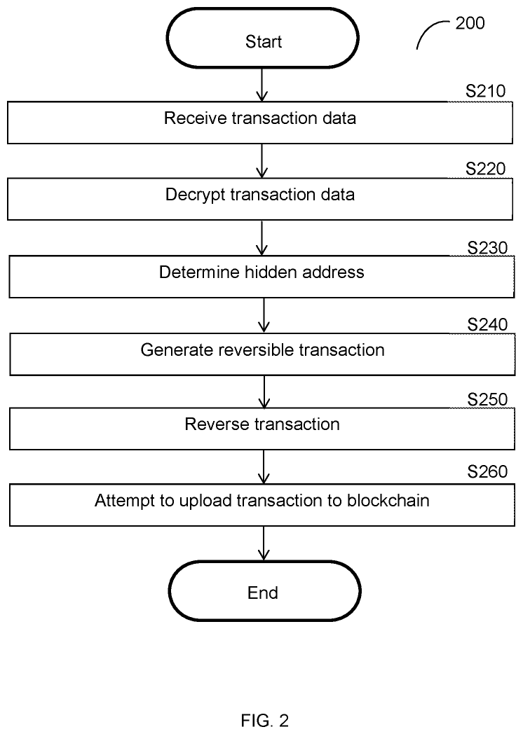

FIG. 2 is an example flowchart 200 illustrating a method for creating reversible blockchain transactions according to an embodiment. In an embodiment, the method is performed by the reversible transaction generator 130, FIG. 1.

At S210, signed transaction data is received from a first user device (e.g., the user device 120-1, FIG. 1) operated by a first party. The signed transaction data is signed by the first user device, and includes data related to a transaction between the first party and a second party. More specifically, the transaction includes transfer of an asset or portion thereof from the first party to the second party and is initiated by a blockchain-utilizing application installed on the first user device. In an example implementation, the transaction is a cryptocurrency transaction involving the transfer of cryptocurrency, and the blockchain-utilizing application is a wallet program which tracks an amount of cryptocurrency available to the first party (i.e., cryptocurrency funds) and allows for transferring part or all of that amount to another party (e.g., the second party).

At S220, the signed transaction data is decrypted using a decryption key received from a second user device operated by a second party to the transaction. The decryption key is generated based on data passed from the first user device to the second user device before being transmitted to the system performing the method of FIG. 2. If the signed transaction data mistakenly reaches an unintended recipient, the unintended recipient will lack the required key and will therefore be unable to successfully upload a transaction including the transaction data to the blockchain.

In an example implementation, the key is generated consistent with the diagram depicted in FIG. 4. FIG. 4 is an example data transmission diagram 400 utilized to describe generation of the key for decrypting the signed transaction data according to an embodiment. The systems described with respect to FIG. 4 are discussed with reference to components of the network diagram 100, FIG. 1.

The data transmission diagram 400 shows communications among the user device 120-1, the user device 120-2, and the reversible transaction generator 130. Transmissions 410-1 and 410-2 illustrate data transmitted during or shortly after the user devices 120-1 and 120-2 initiate the transaction.

In the embodiment shown in FIG. 4, the user device 120-1 encrypts transaction data (not shown) pursuant to a transaction initiated between the user devices 120-1 and 120-2. The user device 120-1 generates a key consisting of two or more portions. For the sake of simplicity, the embodiment shown in FIG. 4 will be described with respect to a key split into a first portion and a second portion. The user device 120-1 encrypts the transaction data such that the encrypted transaction data can be decrypted only when all portions of the key are assembled.

Before that, at transmission 410-1, the user device 120-2 transmits its own identifier to the user device 120-1. In an example implementation, the identifier of the user device 120-2 may be an address indicating a location of the user device 120-2 (e.g., a network location). In transmission 410-2, the user device 120-1 sends the first portion of the key to the user device 120-2.

In transmission 420, the user device 120-1 sends data used for the reversible transaction to the reversible transaction generator 130. In an embodiment, such data includes the encrypted transaction data, the identifier of the user device 120-2 received from the user device 120-2, and the second portion of the key. It should be noted that the transmission 420 is depicted as a single transmission, but the data transmitted in transmission 420 may occur over separate transmissions without departing from the scope of the disclosure.

At transmission 430, the user device 120-2 sends its own identifier to the reversible transaction generator 130. By sending the identifier of the user device 120-2 from both the user device 120-1 and the user device 120-2, the reversible transaction generator 130 may verify that the user device 120-2 is the other party to the transaction indicated in the transaction data sent by the user device 120-1.

At transmission 440, the reversible transaction generator 130 sends the second portion of the key received from the user device 120-1 to the user device 120-2. In an embodiment, transmission 440 occurs when the identifier sent by both user devices 120-1 and 120-2 matches.

Based on the first portion of the key received from the user device 120-1 and the second portion of the key received from the reversible transaction generator 130, the user device 120-2 assembles the full key. Then, at transmission 250, the user device 120-2 sends the assembled full key to the reversible transaction generator 130, thereby allowing the reversible transaction generator 130 to decrypt the encrypted transaction data sent to it by the user device 120-1.

By splitting the key into portions and distributing the portions between the reversible transaction generator 130 and the user device 120-2, the reversible transaction is secured without a single point of failure. If a system other than the reversible transaction generator 130 or the user device 120-2 receives the encrypted transaction data, that system will not be able to decrypt the encrypted transaction data and therefore will not be able to utilize the transaction data.

It should be noted that the embodiment shown in FIG. 4 is merely an example, and that embodiments using other communication configurations may be equally utilized. For example, in another embodiment (not shown), rather than exchanging data among two user devices, data may be exchanged between two blockchain-utilizing applications installed on the same user device. Such an embodiment may be utilized to provide backup and inheritance functionality for a user of the user device who owns both of the blockchain-utilizing applications.

To this end, in an embodiment, a first application and a second application communicate with each other and with the reversible transaction generator 130 generally as depicted in FIG. 4. A user of the user device on which the first and second applications are installed can initiate a future transaction designating transfer of an asset from the first application to the second application to occur at a future time. The future transaction is encrypted in accordance with the disclosed embodiments and generally using the key portions as described with respect to FIG. 4. More specifically, an address for the future transaction is designated as an address accessible to the second application.

The future transaction can be a hidden address as described herein or can be a non-hidden address. The future transaction is encrypted and sent to the reversible transaction generator 130 but not broadcast to a blockchain (e.g., the blockchain 145, FIG. 1). While the future transaction has not yet been broadcast to the blockchain, the user of the user device is able to access and utilize the assets via the first application. From time-to-time (e.g., periodically), the user of the user device may be required to conduct subsequent future transactions as backup transactions, for example as new assets become available to the first application.

If the user wishes to change ownership of the assets to the second application (for example, if the user loses access to the first application or the data in the first application is deleted), the user may complete the transaction by providing the second portion of the key to the reversible transaction generator 130 via the second application. In response, the reversible transaction generator 130 broadcasts the transaction, thereby completing transfer of the asset to the second application.

The transfers described herein (and, in particular, the backup and inheritance) may be further subject to one or more rules providing additional restrictions or features. As non-limiting examples, such rules may include a time limit (i.e., a period of time after which the transaction will be broadcast if it has not already been broadcast), enabling inheritance for multiple addresses (e.g., addresses accessible to multiple different applications), a requirement to provide multiple second portions of a key that are distributed among multiple applications or other entities such that the full key is only assembled when all entities are involved in the transaction, and the like.

Returning to FIG. 2, at S230, a hidden address is determined for the transaction. The hidden address is an internal address of the device on which the blockchain-utilizing application is installed including one or more parameters that causes the hidden address to be inaccessible to the blockchain-utilizing application. Such inaccessibility-causing parameters, when included as part of the hidden address, define a path that the blockchain-utilizing application is not configured to scan for and, consequently, will not be recognized by the blockchain-utilizing application. More specifically, the blockchain-utilizing application may be configured only to scan for a subset of potential addresses of the device, and the hidden address is outside of the subset (i.e., one of the potential addresses of the device that is not among the subset).

In an embodiment, the hidden address determined for the transaction uses one or more nonstandard parameters in the path such that the blockchain-utilizing application installed on the first user device will not recognize the presence of the transferred data. In other words, the nonstandard parameters render the location indicated by the hidden address as unknown to the blockchain-utilizing application on the first user device. In an example implementation, the nonstandard parameter is a value of 2 for “change.” This value of 2 may represent, for example, that the address is internal to the first user device but inaccessible to the blockchain-utilizing application installed thereon. It should be noted that the example nonstandard “change” parameter is non-limiting, and that other parameters may be equally utilized without departing from the scope of the disclosure.

In this regard, it has been identified that blockchain-utilizing applications typically only scan for a limited subset of possible addresses (e.g., a subset including only standard parameters). In the example standard format noted above, the number of potential paths using standard parameters is 2³², or over 4 billion. Applications cannot efficiently scan too many potential paths and, therefore, will not recognize potential paths including nonstandard parameters. As a result, the applications will not be able to access such paths. The disclosed embodiments utilize this characteristic of blockchain-utilizing applications in order to create addresses that are valid but inaccessible to the blockchain-utilizing applications. A transaction can therefore be reversed by accessing the data of the transferred asset in the hidden location. Further, when the transaction is reversed and the transferred asset is used or otherwise subsequently transfer, any attempt by the intended recipient to access the transferred asset is rendered invalid, thereby preventing any potential double spending problems.

At S240, a reversible transaction is generated based on the decrypted transaction data and the hidden address. Generating the transaction includes creating data formatted according to an applicable blockchain protocol such that the data is suitable to be uploaded to a blockchain (e.g., the blockchain 145, FIG. 1) and determining an address on the blockchain at which a block including the transaction data will be stored.

In an embodiment, the address used by the generated transaction is the hidden address. As a result, the blockchain-utilizing application identifies that the asset has been transferred and therefore is inaccessible to the first party. However, the data for the asset remains available to the first user device, and can be accessed upon reversal of the transaction. In an embodiment, the transaction may be reversed until the transaction is successfully uploaded to the blockchain.

A standard format for blockchain addresses used in the Bitcoin context is “m/purpose/coin_type/account/change/address_index.” This format indicates the path resulting in the address. The value of “purpose” is typically 44 as determined based on a standard such as BIP43. For Bitcoin, the value of “coin_type” is “Bitcoin.” However, other coin types such as, but not limited to, Litecoin or Name coin, may be equally utilized without departing from the scope of the disclosure. The value of “account” is a value representing a particular user identity. The value of “chain” is used to indicate whether the address is internal to the user device making the Bitcoin transaction (typically represented by the value 1) or external to that user device (typically represented by the value 0). The value of “address_index” is the value representing the data index of the stored transaction data. As a non-limiting example, an address formatted according to this standard format may be “m/49/0/1/0/24.”

At optional S250, the reversible transaction may be reversed. In an embodiment, S250 includes granting the blockchain-utilizing application access to the hidden address such that the blockchain-utilizing application can access the data related to the asset that would have been transferred via the reversible transaction had such transaction not been reversed. Such data may include, but is not limited to, an indication of an available amount of funds, a digital asset, and the like.

At S260, an attempt is made to upload the transaction to the blockchain. In an embodiment, S260 includes uploading the decoded transaction data to the determined address.

In an embodiment, if the transaction has been reversed since the signed transaction data was received (e.g., as described with respect to S250), an attempt to broadcast the generated transaction to the blockchain will fail. More specifically, if the transaction has been reversed by accessing the asset data at the hidden address, the asset will no longer be available to be transferred via the transaction and the upload will fail.

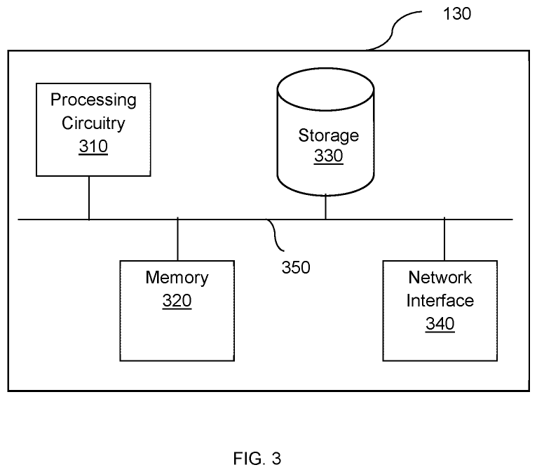

FIG. 3 is an example schematic diagram of a reversible transaction generator 130 according to an embodiment. The reversible transaction generator 130 includes a processing circuitry 310 coupled to a memory 320, a storage 330, and a network interface 340. In an embodiment, the components of the reversible transaction generator 130 may be communicatively connected via a bus 350.

The processing circuitry 310 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 320 may be volatile (e.g., random access memory, etc.), non-volatile (e.g., read only memory, flash memory, etc.), or a combination thereof.

In one configuration, software for implementing one or more embodiments disclosed herein may be stored in the storage 330. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 310, cause the processing circuitry 310 to perform the various processes described herein.

The storage 330 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 340 allows the reversible transaction generator 130 to communicate with the user devices 120 for the purpose of receiving, for example, transaction data, keys for decrypting data or portions thereof, and the like. Further, the network interface 340 allows the reversible transaction generator 130 to communicate with the blockchain network 140 for the purpose of uploading data to the blockchain 145.

It should be understood that the embodiments described herein are not limited to the specific architecture illustrated in FIG. 3, and other architectures may be equally used without departing from the scope of the disclosed embodiments.

It should be noted that, although various embodiments are described in the context of cryptocurrency transactions, the disclosed embodiments may be equally applicable to non-financial transactions. Generally, any blockchain implementations in which it may be desirable to restore data or permissions that have been transferred to another system or device may be improved by allowing for reversing transactions. If the other system or device is lost (or the data stored thereon is lost), the original transaction granting the data may be reversed such that the data may be restored to the transferring party.

As a non-limiting example for another implementation of the disclosed embodiments, an application may be installed on a smart device or car key (i.e., a physical key including a processing circuitry and memory) and a signature required to unlock or operate a vehicle may be stored thereon in a process involving recording the transfer on a blockchain. The transfer of the asset providing access to the vehicle may be performed as described herein such that the transaction is reversible, for example, in the event that the smart device or key is lost. In accordance with the disclosed embodiments, loss of the smart device or key (or the signature stored thereon) can be corrected by restoring the signature data in the original system that transferred that data to the smart device or key.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for creating reversible blockchain transactions, comprising:
determining a hidden address for a transaction to be uploaded to a blockchain, wherein the hidden address is an internal address of a device indicating at least one parameter that causes the hidden address to be inaccessible to a blockchain-utilizing application installed on the device; and
generating a reversible transaction based on the determined hidden address.

2. The method of claim 1, further comprising:
uploading the generated transaction to the blockchain at the determined hidden address when the transaction has not been reversed within a predetermined period of time.

3. The method of claim 1, further comprising:
granting the blockchain-utilizing application access to the hidden address; and
reversing the transaction, wherein reversing the transaction further comprises accessing the hidden address via the blockchain-utilizing application.

4. The method of claim 1, wherein the blockchain-utilizing application installed on the device is a first blockchain-utilizing application, further comprising:
decrypting transaction data using a key received from a second blockchain-utilizing application, wherein the transaction data is signed by the first blockchain-utilizing application, wherein the transaction is generated based on the decrypted transaction data.

5. The method of claim 4, wherein the second blockchain-utilizing application is installed on a second device, wherein the key is generated based on data sent from the first user device to the second user device.

6. The method of claim 1, wherein the blockchain-utilizing application is configured only to scan for a subset of a plurality of potential addresses of the device, wherein the hidden address is outside of the subset.

7. The method of claim 1, wherein the transaction includes a transfer of an asset, wherein the hidden address includes a change parameter value, wherein the change parameter value indicates a visibility of asset data of the asset to the first user device.

8. The method of claim 1, wherein the hidden address is a smart address including logic that, when executed, prevents the blockchain-utilizing application installed on the first user device from accessing the hidden address.

9. The method of claim 8, wherein the logic of the hidden address defines a list of blocked applications that are not permitted to access the hidden address.

10. A non-transitory computer readable medium having stored thereon instructions for causing a processing circuitry to execute a process, the process comprising:
determining a hidden address for a transaction to be uploaded to a blockchain, wherein the hidden address is an internal address of a device indicating at least one parameter that causes the hidden address to be inaccessible to a blockchain-utilizing application installed on the device; and
generating a reversible transaction based on the determined hidden address.

11. A system for creating reversible blockchain transactions, comprising:
a processing circuitry; and
a memory, the memory containing instructions that, when executed by the processing circuitry, configure the system to:
determine a hidden address for a transaction to be uploaded to a blockchain, wherein the hidden address is an internal address of a device indicating at least one parameter that causes the hidden address to be inaccessible to a blockchain-utilizing application installed on the device; and
generate a reversible transaction based on the determined hidden address.

12. The system of claim 11, wherein the system is further configured to:
upload the generated transaction to the blockchain at the determined hidden address when the transaction has not been reversed within a predetermined period of time.

13. The system of claim 11, wherein the system is further configured to:
grant the blockchain-utilizing application access to the hidden address; and
reverse the transaction, wherein reversing the transaction further comprises accessing the hidden address via the blockchain-utilizing application.

14. The system of claim 11, wherein the blockchain-utilizing application installed on the device is a first blockchain-utilizing application, wherein the system is further configured to:
decrypt transaction data using a key received from a second blockchain-utilizing application, wherein the transaction data is signed by the first blockchain-utilizing application, wherein the transaction is generated based on the decrypted transaction data.

15. The system of claim 14, wherein the second blockchain-utilizing application is installed on a second device, wherein the key is generated based on data sent from the first user device to the second user device.

16. The system of claim 11, wherein the blockchain-utilizing application is configured only to scan for a subset of a plurality of potential addresses of the device, wherein the hidden address is outside of the subset.

17. The system of claim 11, wherein the transaction includes a transfer of an asset, wherein the hidden address includes a change parameter value, wherein the change parameter value indicates a visibility of asset data of the asset to the first user device.

18. The system of claim 11, wherein the hidden address is a smart address including logic that, when executed, prevents the blockchain-utilizing application installed on the first user device from accessing the hidden address.

19. The system of claim 18, wherein the logic of the hidden address defines a list of blocked applications that are not permitted to access the hidden address.
